(19) United States
(12) Patent Application Publication
(10) Pub. No.: US 2007/0093138 A1
(43) Pub. Date: Apr. 26, 2007

(54) Electronic card connection devices

(75) Inventor: Wei Min Su, Jiangsu (CN)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/487,126

(22) Filed: Jul. 13, 2006

(30) Foreign Application Priority Data
Jul. 14, 2005 (TW) TW94123896

(51) Int. Cl. H01R 24/00

(52) U.S. Cl. 439/630

(57) ABSTRACT

Electronic card connection devices are provided. An electronic card connection device includes a bottom plate, a first and a second fixing components, and an elastic structure. The bottom plate includes a first and a second lateral parts opposite to each other. The first fixing component and the first lateral part form a first disposition space. The second fixing component and the second lateral part form a second disposition space. When an electronic card is at a first location, the electronic card is partly in the first disposition space and independent of the second disposition space, allowing the electronic card to exit. When the electronic card is at a second location, the electronic card is partly in the first and second disposition spaces, and resilience supplied by the elastic structure forces the electronic card to substantially contact the first and second fixing components, thus, the electronic card is fixed therein.

### BACKGROUND

The invention relates to electronic card connection devices, and in particular, to electronic card connection devices with short card inserting or removing distance and electronic card connection modules utilizing the same.

Subscriber identify module (SIM) cards are electronic cards commonly applied in cellular phones for identifying authorized users. Typically, SIM cards are fixed and electrically connected to cellular phones by SIM card connection devices.

One of the basic requirements in design of SIM card connection devices is to ensure that SIM card connection electronic cards is another consideration.

FIG. 1a is a back view of a conventional SIM card 101. FIG. 1b is a schematic view of a conventional SIM card connection device 100.

As shown, the SIM card 101 comprises a plurality of contact points 104. The SIM card connection device 100 comprises a plurality of terminals 105. When the SIM card 101 is disposed in the SIM card connection device 100, the contact points 104 contact the terminals 105 correspondingly, thereby electrically connecting the SIM card 101 to the SIM card connection device 100.

FIG. 1c is a schematic view of the SIM card connection device 100 configured in a cellular phone 500, wherein the SIM card 101 is not disposed therein. FIG. 1d is a schematic view of the SIM card connection device 100 configured in the cellular phone 500, wherein the SIM card 101 is disposed therein. FIG. 1e is a schematic view of the SIM card connection device 100 configured in the cellular phone 500, wherein a user removes the SIM card 101 along the direction of arrow 600.

As shown, the SIM card connection device 100 comprises a fixing portion 102 for fixing the SIM card 101 therein. To remove the SIM card 101 from the SIM card connection device 100, the SIM card 101 must be moved by a considerable distance 103, such as 13 mm therein, along the direction of arrow 600 due to a limitation of the fixing portion 102. Therefore, neighboring components must be limited to an appropriate height, thus affecting the dimensions, performance, electrostatic discharge (ESO) ability, and electric conductivity of the cellular phone 500.

### SUMMARY

Electronic card connection devices with short card-removing distance and electronic card connection modules utilizing the same are provided.

An exemplary embodiment of an electronic card connection device comprises a bottom plate, a first fixing component, a second fixing component, and an elastic structure. The electronic card connection device is used for fixing an electronic card comprising a first side and a second side opposite to each other. The bottom plate comprises a first lateral part and a second lateral part opposite to each other. The first and second fixing components are disposed on the first and second lateral parts respectively. The first fixing component and the first lateral part form a first disposition space. The second fixing component and the second lateral part form a second disposition space. The elastic structure is disposed on the bottom plate for supplying resilience. When the electronic card is at a first location, the first side is substantially in the first disposition space, and the second side is independent of the second disposition space, thereby allowing the electronic card to exit the electronic card connection device. When the electronic card is at a second location, the first and second sides are substantially in the first and second disposition spaces respectively, and the resilience is applied on the electronic card to force the first and second sides to substantially contact the first and second fixing components respectively, thereby holding the electronic card in the electronic card connection device.

An exemplary embodiment of an electronic card connection module comprises a circuit board, an electronic card connection device as previously described, and an electronic card. The electronic card connection device further comprises a first blocking component and a second blocking component disposed on the first and second lateral parts respectively for blocking the electronic card from exiting the electronic card connection device. The elastic structure comprises a plurality of terminals electrically connected to the circuit board. The electronic card comprises a plurality of contact points, a first side, and a second side. The first and second sides are opposite to each other. When the electronic card is at a third location, the first and second sides substantially contact the first and second blocking components respectively, and the contact points contact the terminals correspondingly, thereby retaining the electronic card at the third location and electrically connecting the electronic card to the circuit board.

### DESCRIPTION OF THE DRAWINGS

The invention can be more fully understood by reading the subsequent detailed description and examples with references made to the accompanying drawings, wherein:

FIG. 1a is a back view of a conventional SIM card;

FIG. 1b is a schematic view of a conventional SIM card connection device;

FIG. 1c is a schematic view of a conventional SIM card connection device configured in a cellular phone, wherein no SIM card is disposed therein;

FIG. 1d is a schematic view of a conventional SIM card connection device configured in a cellular phone, wherein a SIM card is disposed therein;

FIG. 1e is a schematic view of a conventional SIM card connection device configured in a cellular phone, wherein a user removes a SIM card along the direction shown by the arrow;

FIG. 2a is a back view of an embodiment of an electronic card of the invention;

FIG. 2b is a schematic view of an embodiment of an electronic card connection device of the invention;

FIG. 2c is a schematic view of an embodiment of an electronic card connection module;

FIG. 3a is a right view of an embodiment of an electronic card connection module, wherein a user disposes an electronic card in an electronic card connection device at an appropriate angle;

FIG. 3b is a right view of an embodiment of an electronic card connection module, wherein a user applies force to press an electronic card downward to a first location;

FIG. 3c is a top view of an embodiment of an electronic card connection module, wherein an electronic card is at a first location;

FIG. 3d is a top view of an embodiment of an electronic card connection module, wherein an electronic card is at a second location; and

FIG. 3e is a top view of an embodiment of an electronic card connection module, wherein an electronic card is at a third location.

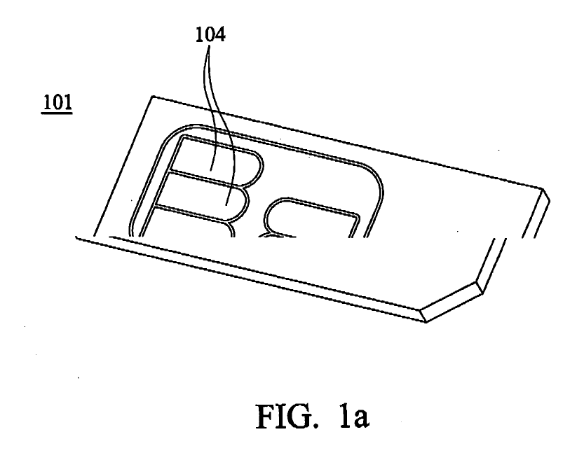

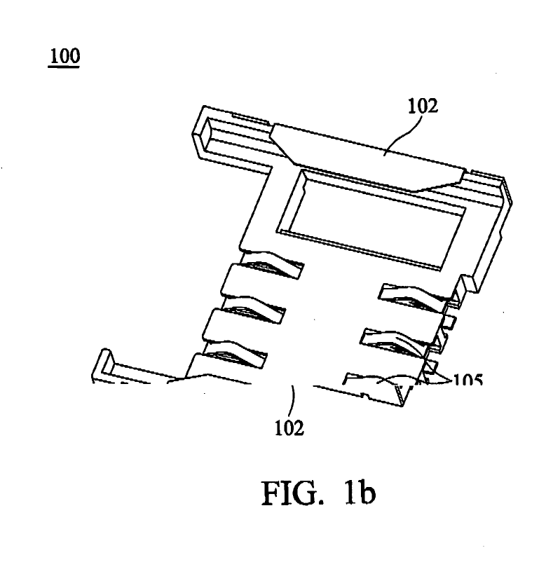

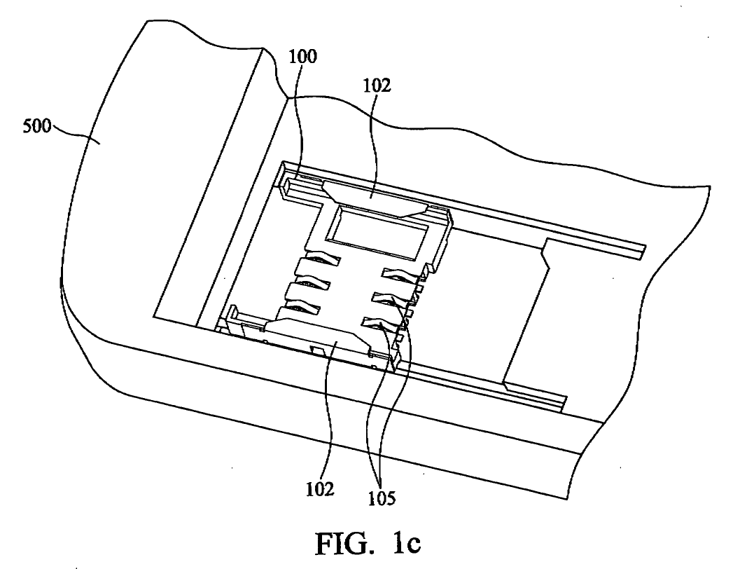

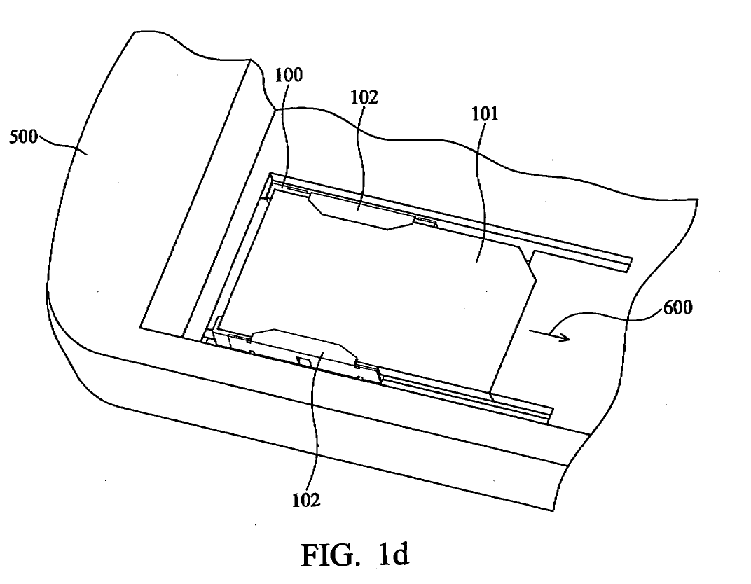

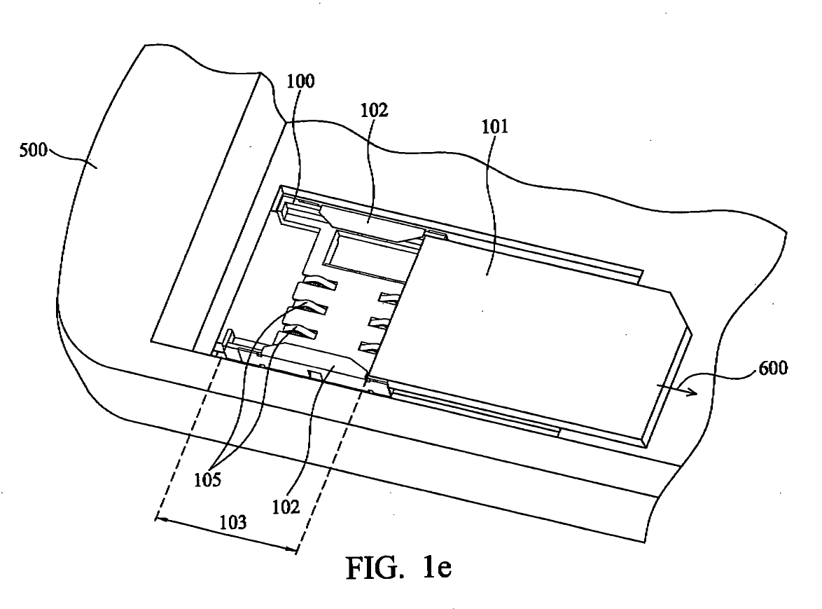

### DETAILED DESCRIPTION

A principle aim of the invention is to allow an electronic card to enter an electronic card connection device from above at an oblique angle, thus the distance required for placing or removing the electronic card is reduced.

Generally speaking, to dispose an electronic card in an electronic card connection device, the electronic card is inserted in the electronic card connection device at an appropriate angle from above, pressed downward, and then moved by an appropriate distance towards a fixing portion of the electronic card connection device. Therefore, the electronic card is fixed in the electronic card connection device. Additionally, a user can execute the above procedure in reverse to remove the electronic card from the electronic card connection device.

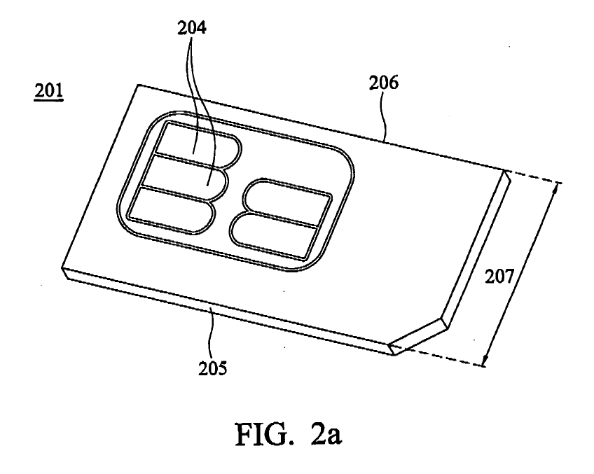

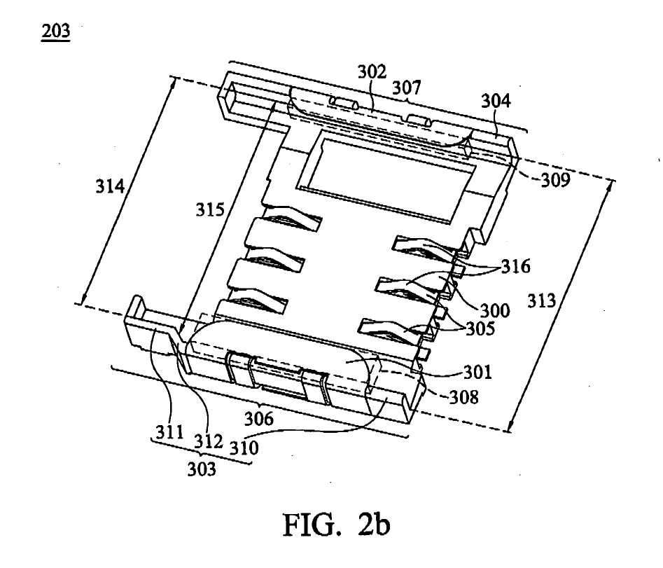

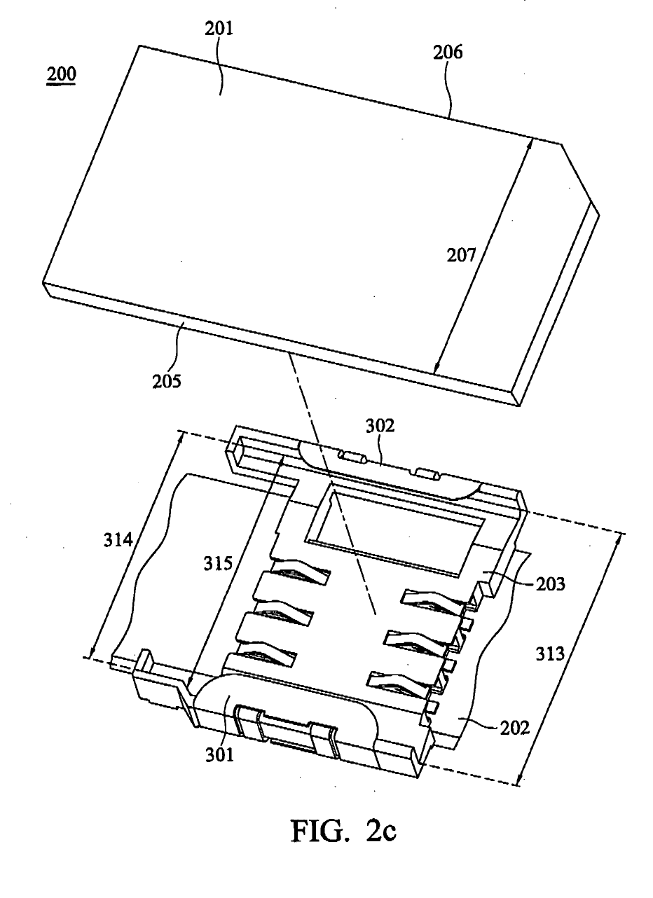

FIG. 2a is a back view of an embodiment of an electronic card 201. FIG. 2b is a schematic view of an embodiment of an electronic card connection device 203. FIG. 2c is a schematic view of an embodiment of an electronic card connection module 200.

The electronic card connection module 200 comprises the electronic card 201, a circuit board 202, and the electronic card connection device 203.

Te electronic card 201 is a subscriber identity module (SIM) card comprising a plurality of contact points 204, a first side 205, and a second side 206. The first and second sides 205, 206 are opposite to each other. The electronic card 201 has a fixed width 207.

The electronic card connection device 203 comprises a bottom plate 300, a first fixing component 301, a second fixing component 302, a first blocking component 303, a second blocking component 304, and an elastic structure 305.

The bottom plate 300 comprises a first lateral part 306 and a second lateral part 307 opposite to each other.

The first and second fixing components 301, 302 are disposed on the first and second lateral parts 306, 307. The first fixing component 301 and the first lateral part 306 form a first disposition space 308. The second fixing component 302 and the second lateral part 307 form a second disposition space 309.

Additionally, the first and second fixing components 301 and 302 are above the bottom plate 300 face to face and virtually parallel with the bottom plate 300.

The first and second blocking components 303 and 304 extend virtually upward from the first and second lateral parts 306 and 307 respectively for blocking the electronic card 201 from exiting the electronic card connection device 203.

Moreover, the first blocking component 303 comprises a first segment 310, a second segment 311, and a third segment 312.

A distance 313 between the first segment 310 and a corresponding part of the second blocking component 304 is greater than the fixed width 207 of the electronic card 201. A distance 314 between the second segment 311 and a corresponding part of the second blocking component 304 is substantially equal to the fixed width 207 of the electronic card 201.

The third segment 312 is between the first and second segments 310 and 311. A distance 315 between the third segment 312 and a corresponding part of the second blocking component 304 decreases in a direction from the first segment 310 to the second segment 311.

The elastic structure 305 is a plurality of metal spring sheets disposed on the bottom plate for supplying upward resilience. The elastic structure 305 comprises a plurality of terminals 316 and electrically connects to the circuit board 202 thereby.

The mechanism enabling the electronic card 201 to enter and exit the electronic card connection device 203 will be described in detail in the following.

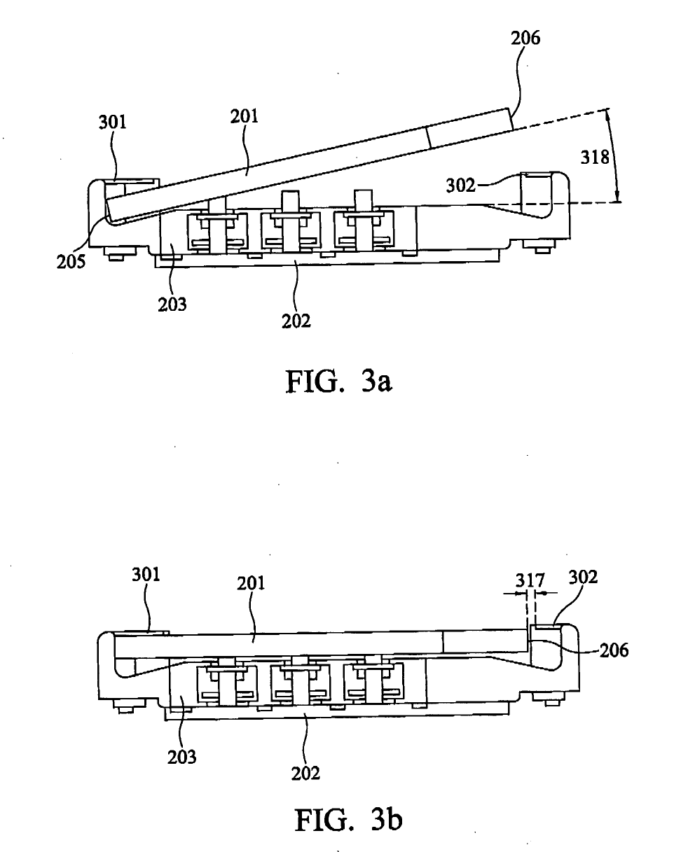

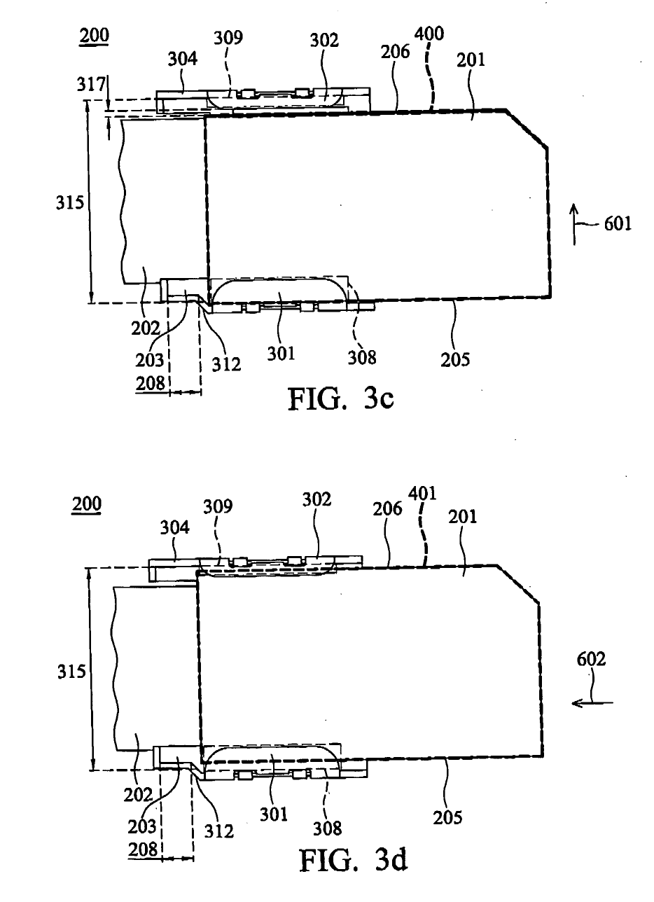

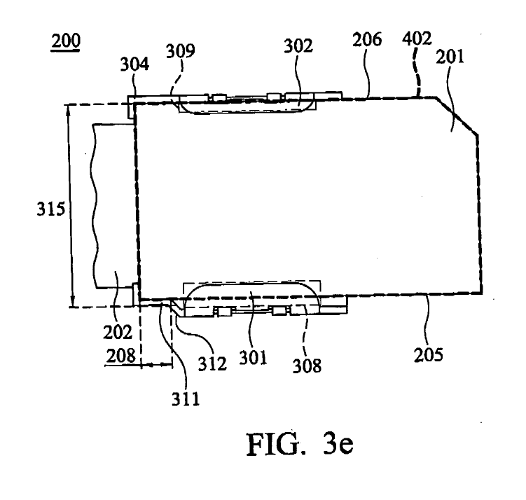

FIG. 3a is a right view of the electronic card connection module 200, wherein a user disposes the electronic card 201 in the electronic card connection device 203 at an appropriate angle 318. FIG. 3b is a right view of the electronic card connection module 200, wherein the user applies force to press the electronic card 201 downward to a first location 400. FIG. 3c is a top view of the electronic card connection module 200, wherein the electronic card 201 is at the first location 400. FIG. 3d is a top view of the electronic card connection module 200, wherein the electronic card 201 is at a second location 401. FIG. 3e is a top view of the electronic card connection module 200, wherein the electronic card 201 is at a third location 402.

As shown in FIGS. 3a and 3b, to dispose the electronic card 201 in the electronic card connection device 203, the electronic card 201 is inserted in the electronic card connection device 203 at the appropriate angle 318 from above and then pressed downward to the first location 400 by an external force.

When the electronic card 201 is at the first location 400, the first side 205 is substantially in the first disposition space 308, and the second side 206 is independent of the second disposition space 309.

The distance 317 between the second side 206 and the second fixing component 302 is enough to enable the electronic card 201 can be easily inserted in or removed from the electronic card connection device 203, for example, the distance is bigger than 0.2 mm is the better.

The electronic card 201 is then pushed to the second location 401 along the direction of arrow 601.

As shown in FIG. 3d, when the electronic card 201 is at the second location 401, the first side 205 is substantially in the first disposition space 308, and the second side 206 is substantially in the second disposition space 309.

The resilience supplied by the elastic structure 305 (shown in FIG. 2b) is then applied to the electronic card 301 and 302 respectively. Thus, the electronic card 201 is held in the electronic card connection device 203.

The electronic card 201 is further pushed to the third location 402 along the direction of arrow 602.

As shown in FIG. 3e, when the electronic card 201 is at the third location 402, the first and second sides 205 and 206 substantially contact the second segment 311 and a corresponding part of the second blocking component 304 respectively. Thus, the electronic card 201 is held at the third location 402.

Additionally, the contact points 204 contact the terminals 316 correspondingly, such that the electronic card 201 connects to the circuit board 202 electrically.

Thus, the user completes the procedure of disposing the electronic card 201 in the electronic card connection device 203.

Moreover, the user can execute the above procedure in reverse to remove the electronic card 201 from the electronic card connection device 203.

Additionally, a distance 315 between the third segment 312 and a corresponding part of the second blocking component 304 decreases in a direction from the first segment 310 to the second segment 311, such that the electronic card 201 can be easily placed in or removed from the third location 402.

Additionally, in this embodiment, a distance 208 [symbol] 3 mm, that is more less than 13 mm before.

In some embodiments of an electronic card connection module, an electronic card is inserted in an electronic card connection device at an appropriate angle from above, pressed downward, and then pushed an appropriate distance toward a fixing portion of the electronic card connection device. Thus, the electronic card is fixed in the electronic card connection device. Additionally, a user can execute the above procedure in reverse to remove the electronic card from the electronic card connection device.

In some embodiments of an electronic card connection module, an electronic card is allowed to enter an electronic card connection device from above at an oblique angle, thus the distance required for placing or removing the electronic card is reduced. The dimension of a cellular phone utilizing the electronic card connection module can also be reduced. Additionally, flexibility in design and disposition of components in the cellular phone can also be enhanced.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic card connection device for fixing an electronic card, wherein the electronic card comprises a first side and a second side opposite to each other, comprising:
a bottom plate, comprising a first lateral part and a second lateral part opposite to each other;
a first fixing component and a second fixing component, disposed on the first and second lateral parts respectively, wherein the first fixing component and the first lateral part form a first disposition space, and the second fixing component and the second lateral part form a second disposition space; and
an elastic structure, disposed on the bottom plate for supplying resilience;
wherein when the electronic card is at a first location, the first side is substantially in the first disposition space, and the second side is independent of the second disposition space, thereby allowing the electronic card to exit from the electronic card connection device, and when the electronic card is at a second location, the first and second sides are substantially in the first and second disposition spaces respectively, and the resilience is applied on the electronic card to force the first and second sides to substantially contact the first and second fixing components respectively, thereby retaining the electronic card in the electronic card connection device.

2. The electronic card connection device as claimed in claim 1, wherein the first and second fixing components are above the bottom plate face to face and virtually parallel with the bottom plate.

3. The electronic card connection device as claimed in claim 2, wherein the resilience is projected upward.

4. The electronic card connection device as claimed in claim 1 further comprising a first blocking component and a second blocking component disposed on the first and second lateral parts respectively for blocking the electronic card from exiting the electronic card connection device.

5. The electronic card connection device as claimed in claim 4, wherein the first and second blocking components extend virtually upward.

6. The electronic card connection device as claimed in claim 4, wherein the first blocking component comprises a first segment and a second segment.

7. The electronic card connection device as claimed in claim 6, wherein the electronic card has a fixed width, a distance between the first segment and a corresponding part of the second blocking component is greater than the fixed width of the electronic card, and a distance between the second segment and a corresponding part of the second blocking component is substantially equal to the fixed width of the electronic card.

8. The electronic card connection device as claimed in claim 6, wherein when the electronic card is at a third location, the first and second sides substantially contact the second segment and a corresponding part of the second blocking component respectively, thereby holding the electronic card at the third location.

9. The electronic card connection device as claimed in claim 8, wherein the first blocking component further comprises a third segment between the first and second segments, and a distance between the third segment and a corresponding part of the second blocking component decreases in a direction from the first segment to the second segment, thereby leading the electronic card to or out of the third location.

10. The electronic card connection device as claimed in claim 8, wherein the electronic card further comprises a plurality of contact points, the elastic structure comprises a plurality of terminals electrically connected to a circuit board, and when the electronic card is at the third location, the contact points contact the terminals correspondingly, thereby electrically connecting the electronic card to the circuit board.

11. The electronic card connection device as claimed in claim 1, wherein when the electronic card is at the first location, a distance between the second side and the second fixing component is greater than 0.2 mm.

12. The electronic card connection device as claimed in claim 1, wherein the electronic card is a subscriber identity module (SIM) card.

13. The electronic card connection device as claimed in claim 1, wherein the elastic structure is a plurality of metal spring sheets.

14. An electronic card connection module, comprising:
a circuit board;
an electronic card connection device as claimed in claim 1, wherein the electronic card connection device further comprises a first blocking component and a second blocking component disposed on the first and second lateral parts respectively for blocking the electronic card from exiting the electronic card connection device, and the elastic structure comprises a plurality of terminals electrically connected to the circuit board; and
an electronic card, comprising a plurality of contact points, a first side, and a second side, wherein the first and second sides are opposite to each other;
wherein when the electronic card is at a third location, the first and second sides substantially contact the first and second blocking components respectively, and the contact points contact the terminals correspondingly, thereby retaining the electronic card at the third location and electrically connecting the electronic card to the circuit board.
